(19) United States
(12) Patent Application Publication
(10) Pub. No.: US 2001/0006227 A1
(43) Pub. Date: Jul. 5, 2001

(54) Liquid crystal display element

(76) Inventors: Nobuyuki Kobayashi, Kobe-Shi (JP); Masako Iwamatsu, Toyonaka-Shi (JP); Katsuhiko Asai, Takatsuki-Shi (JP)

Correspondence Address: SIDLEY AUSTIN BROWN & WOOD, 717 NORTH HARWOOD, SUITE 3400, DALLAS, TX, 75201, US

(21) Appl. No.: 09/749,476

(22) Filed: Dec. 26, 2000

(30) Foreign Application Priority Data
Dec. 28, 1999 (JP) 11-375549

(51) Int. Cl. C09K 19/00; C09K 19/52; C09K 19/60; G02F 1/1333

(52) U.S. Cl. 252/299.01; 428/1.1; 252/299.1

(57) ABSTRACT

A liquid crystal display element has a liquid crystal layer including at least nematic liquid crystal composition and a chiral agent and held between a pair of substrates. The nematic liquid crystal composition includes a main component formed of at least one kind of liquid crystal pyrimidine compound, and the following conditions are satisfied:

Δn×(k33/k11)/(main component ratio)<0.4

where Δn is a refractive index anisotropy, k33 is a bend elastic constant, k11 is a spray elastic constant with respect to said nematic liquid crystal composition, and the main component ratio is a content ratio (% by weight) of the main component of the nematic liquid crystal composition to the nematic liquid crystal composition.

The invention is based on patent application No. 11-375549 Pat. filed in Japan, the contents of which are hereby incorporated by reference.

### BACKGROUND OF THE INVENTION

1. Field of the Invention

The present invention relates to a liquid crystal display element.

2. Description of the Background Art

In recent years, research has been made to provide a liquid crystal display element using a chiral nematic liquid crystal composition, which is prepared by adding a chiral agent to a nematic liquid crystal composition, and exhibits a cholesteric phase in a room temperature. In this liquid crystal display element, high and low pulse voltages are selectively applied to the liquid crystal so that display can be performed by switching the state between a planar state (selective reflection state) and a focal conic state (scattered state). This kind of liquid crystal display element is used, e.g., as a liquid crystal display element of a reflection type utilizing selective reflection by the cholesteric phase.

For improving particularly the contrast in the liquid crystal display element of the reflection type, it is necessary to improve a quality of transparent display (e.g., black or another background color display).

However, such a liquid crystal display element has not been actually developed or available that can have a good quality of transparent display (e.g., black or another background color display), and is prepared by using the chiral nematic liquid crystal composition, which exhibits a cholesteric phase in a room temperature owing to addition of the chiral agent to the nematic liquid crystal composition material.

### SUMMARY OF THE INVENTION

Accordingly, an object of the invention is to provide a liquid crystal display element, which has a liquid crystal layer including at least nematic liquid crystal composition and a chiral agent and held between a pair of substrates, and can achieve a good quality of transparent display such as display of a black or another background color as well as an improved contrast.

The inventors have made research for achieving the foregoing object, and have found the followings.

In the research, such a liquid crystal display element was used that a liquid crystal layer including at least nematic liquid crystal composition and a chiral agent is held between a pair of substrates. This liquid crystal display element is colored when the liquid crystal layer reflects light having a peak wavelength in a specific wavelength range, and becomes colorless by passing incident light. In this case, the following formula (left side) has been studied as a formula for improving the transparent display quality (e.g., a black or another background color display quality in a liquid crystal display element of a reflection type) in the colorless state:

Δn×(k33/k11)/(main component ratio)<α

where Δn is a refractive index anisotropy of the foregoing nematic liquid crystal composition, k33 is a bend elastic constant of the foregoing nematic liquid crystal composition, k11 is a spray elastic constant of the foregoing nematic liquid crystal composition, and the main component ratio is a content ratio (% by weight) of at least one kind of liquid crystal compound that constitutes a main component of the foregoing nematic liquid crystal composition and has the main component skelton therein to the foregoing nematic liquid crystal composition.

The bend elastic constant k33 and the spray elastic constant k11 are Frank elastic constants with respect to distortions in a bend mode and a spray mode, respectively.

In this liquid crystal display element, the liquid crystal can be switched between a planar state (selective reflection state) and a focal conic state (scattered state) by selectively applying high and low pulse voltages.

The left side (Δn×(k33/k11)) in the foregoing formula can be described as follows.

As Δn (refractive index anisotropy of the nematic liquid crystal composition) decreases, light is scattered in the liquid crystal to a smaller extent. As the value of (k33/k11) decreases (i.e., as the spray elastic constant k11 increases and/or the bend elastic constant k33 decreases), liquid crystal molecules can take a planar structure more easily so that discrimination lines decrease, and therefore scattering of light is suppressed. As Δn increases, the brightness of image display is improved.

In accordance with increase in the main component ratio, i.e., in accordance with increase in amount of the liquid crystal compound having a main component skeleton in the foregoing nematic liquid crystal composition, the discrimination lines decease so that the scattering of light occurs to a smaller extent.

From the above, it is estimated that the scattering components in image display decrease with decrease in value obtained in the left side of the foregoing formula.

Accordingly, the main component of the foregoing nematic liquid crystal composition can be formed of a liquid crystal compound satisfying conditions that the value of (Δn×(k33/k11)) in the left side of the foregoing formula is smaller than the predetermined value α in the right side of the foregoing formula. Thereby, it is possible to suppress unnecessary scattering particularly in the focal conic state, and can improve the transparent display characteristics (e.g., the black or another background color display characteristics in the case of the liquid crystal display element of the reflection type).

For example, liquid crystal pyrimidine compound may be used as the main component of the nematic liquid crystal composition. In this case, the practically excellent transparent display characteristics such as display characteristics of black or another background color can be achieved in the liquid crystal element if the value of α in the foregoing formula is 0.4.

Liquid crystal biphenyl compound and/or liquid crystal terphenyl compound may be used as the main component of the nematic liquid crystal composition. In this case, the practically excellent transparent display characteristics such as display characteristics of black or another background color can be achieved in the liquid crystal element if the value of α in the foregoing formula is 0.8.

Liquid crystal ester compound may be used as the main component of the nematic liquid crystal composition. In this case, the practically excellent transparent display characteristics such as display characteristics of black or another background color can be achieved in the liquid crystal element if the value of α in the foregoing formula is 0.25.

Further, liquid crystal phenylcyclohexane (PCH) compound may be used as the main component of the nematic liquid crystal composition. In this case, the practically excellent transparent display characteristics such as display characteristics of black or another background color can be achieved in the liquid crystal element if the value of α in the foregoing formula is 0.4.

From the findings described above, the invention provides first to fourth liquid crystal display elements described below.

(1) First Liquid Crystal Element

A liquid crystal display element, wherein a liquid crystal layer including at least nematic liquid crystal composition and a chiral agent is held between a pair of substrates, said nematic liquid crystal composition has a main component formed of at least one kind of liquid crystal pyrimidine compound, and the following conditions are satisfied:

Δn×(k33/k11)/(main component ratio)<0.4

where Δn is a refractive index anisotropy of the foregoing nematic liquid crystal composition, k33 is a bend elastic constant of the foregoing nematic liquid crystal composition, k11 is a spray elastic constant of the foregoing nematic liquid crystal composition, and the main component ratio is a content ratio (% by weight) of the main component of the foregoing nematic liquid crystal composition to the foregoing nematic liquid crystal composition.

(2) Second Liquid Crystal Element

A liquid crystal display element, wherein a liquid crystal layer including at least nematic liquid crystal composition and a chiral agent is held between a pair of substrates, said nematic liquid crystal composition has a main component formed of (1) at least one kind of liquid crystal biphenyl compound, (2) at least one kind of liquid crystal terphenyl compound or (3) a mixture of at least one kind of liquid crystal biphenyl compound and at least one kind of liquid crystal terphenyl compound, and the following conditions are satisfied:

Δn×(k33/k11)/(main component ratio)<0.8

where Δn is a refractive index anisotropy of the foregoing nematic liquid crystal composition, k33 is a bend elastic constant of the foregoing nematic liquid crystal composition, k11 is a spray elastic constant of the foregoing nematic liquid crystal composition, and the main component ratio is a content ratio (% by weight) of the main component of the foregoing nematic liquid crystal composition to the foregoing nematic liquid crystal composition.

(3) Third Liquid Crystal Element

A liquid crystal display element, wherein a liquid crystal layer including at least nematic liquid crystal composition and a chiral agent is held between a pair of substrates, said nematic liquid crystal composition has a main component formed of at least one kind of liquid crystal ester compound, and the following conditions are satisfied:

Δn×(k33/k11)/(main component ratio)<0.25

where Δn is a refractive index anisotropy of the foregoing nematic liquid crystal composition, k33 is a bend elastic constant of the foregoing nematic liquid crystal composition, k11 is a spray elastic constant of the foregoing nematic liquid crystal composition, and the main component ratio is a content ratio (% by weight) of the main component of the foregoing nematic liquid crystal composition to the foregoing nematic liquid crystal composition.

(4) Fourth Liquid Crystal Element

A liquid crystal display element, wherein a liquid crystal layer including at least nematic liquid crystal composition and a chiral agent is held between a pair of substrates, said nematic liquid crystal composition has a main component formed of at least one kind of liquid crystal phenylcyclohexane (PCH) compound, and the following conditions are satisfied:

Δn×(k33/k11)/(main component ratio)<0.4

where Δn is a refractive index anisotropy of the foregoing nematic liquid crystal composition, k33 is a bend elastic constant of the foregoing nematic liquid crystal composition, k11 is a spray elastic constant of the foregoing nematic liquid crystal composition, and the main component ratio is a content ratio (% by weight) of the main component of the foregoing nematic liquid crystal composition to the foregoing nematic liquid crystal composition.

In the liquid crystal display elements according to the invention, the bend elastic constant k33 and the spray elastic constant k11 are Frank elastic constants in a bend mode and a spray mode, respectively. Further, the main components of the nematic liquid crystal composition, i.e., liquid crystal pyrimidine compound, liquid crystal biphenyl compound, liquid crystal terphenyl compound, liquid crystal ester compound and liquid crystal phenylcyclohexane (PCH) compound are compounds having liquid crystal molecules, of which main skeletons have molecular structures exhibited by pyrimidine, biphenyl, terphenyl, ester or phenylcyclohexane (PCH), respectively.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic cross section of an example of a liquid crystal display element according to the invention;

FIG. 2 is a schematic cross section of another example of the liquid crystal display element according to the invention; and

FIG. 3 is a schematic cross section of further another example of the liquid crystal display element according to the invention.

### DESCRIPTION OF THE PREFERRED EMBODIMENTS

The following first to fourth liquid crystal display elements will now be described as embodiments of the invention.

(1) First Liquid Crystal Element

A liquid crystal display element, wherein a liquid crystal layer including at least nematic liquid crystal composition and a chiral agent is held between a pair of substrates, said nematic liquid crystal composition has a main compoenet formed of at least one kind of liquid crystal pyrimidine compound, and the following conditions are satisfied:

Δn×(k33/k11)/(main component ratio)<0.4

(2) Second Liquid Crystal Element

A liquid crystal display element, wherein a liquid crystal layer including at least nematic liquid crystal composition and a chiral agent is held between a pair of substrates, said nematic liquid crystal composition has a main component formed of (1) at least one kind of liquid crystal biphenyl compound, (2) at least one kind of liquid crystal terphenyl compound or (3) a mixture of at least one kind of liquid crystal biphenyl compound and at least one kind of liquid crystal terphenyl compound, and the following conditions are satisfied:

Δn×(k33/k11)/(main component ratio)<0.8

(3) Third Liquid Crystal Element

A liquid crystal display element, wherein a liquid crystal layer including at least nematic liquid crystal composition and a chiral agent is held between a pair of substrates, said nematic liquid crystal composition has a main component formed of at least one kind of liquid crystal ester compound, and the following conditions are satisfied:

Δn×(k33/k11)/(main component ratio)<0.25

(4) Fourth Liquid Crystal Element

A liquid crystal display element, wherein a liquid crystal layer including at least nematic liquid crystal composition and a chiral agent is held between a pair of substrates, said nematic liquid crystal composition has a main component formed of at least one kind of liquid crystal phenylcyclohexane (PCH) compound, and the following conditions are satisfied:

Δn×(k33/k11)/(main component ratio)<0.4

In the first to the fourth liquid crystal elements, the Δn is a refractive index anisotropy of the nematic liquid crystal composition, k33 is a bend elastic constant of the nematic liquid crystal composition, k11 is a spray elastic constant of the nematic liquid crystal composition, and the main component ratio is a content ratio (% by weight) of the main component of the nematic liquid crystal composition to the nematic liquid crystal composition.

In the above liquid crystal display elements, the bend elastic constant k33 and spray elastic constant k11 are determined as described before. Further, the liquid crystal pyrimidine compound, liquid crystal biphenyl compound, liquid crystal terphenyl compound, liquid crystal ester compound and liquid crystal phenylcyclohexane (PCH) compound, which are the main components of the nematic liquid crystal composition (i.e., components contained at about 30% or more by weight in the nematic liquid crystal composition material), are formed of liquid crystal molecules, of which main skeletons have molecule structures expressed by pyrimidine, biphenyl, terphenyl, ester or phenylcyclohexane (PCH), respectively, and have ends formed of groups of alkyl, alkoxy, alkenyl, halogen or the like.

The liquid crystal component forming the main component is the largest in content among a plurality of liquid crystal groups each including the same kind of liquid crystal components contained in the nematic liquid crystal composition. It is preferably contained in 30% or more by weight in the nematic liquid crystal composition. In the liquid crystal display element of the second type described above, however, both the liquid crystal biphenyl compound and the liquid crystal terphenyl compound may be contained in the nematic liquid crystal composition. In this case, a mixture of these two kinds of compounds may be handled as the main component because these compounds exhibit similar natures. Although the upper limit is not restricted, it is appropriately equal to about 90% or less by weight.

In addition to the foregoing liquid crystal materials forming the main components, the nematic liquid crystal composition may contain various kinds of known liquid crystal materials such as a liquid crystal cyclohexylcyclohexane (CCH) compound, a liquid crystal polycyclic P-type compound, a liquid crystal polycyclic N-type compound and a liquid crystal tolan compound. The compounds already described, i.e., liquid crystal pyrimidine compound, liquid crystal biphenyl compound, liquid crystal terphenyl compound, liquid crystal ester compound and liquid crystal phenylcyclohexane (PCH) compound may be contained as auxiliary components.

In the first to fourth liquid crystal display elements already described, the liquid crystal layer including at least the nematic liquid crystal composition and the chiral agent is held between the pair of substrates.

It is assumed that the nematic liquid crystal composition has the refractive index anisotropy An, the bend elastic constant k33, the spray elastic constant k11, and the main component ratio determined by a content ratio (% by weight) of the main component of the nematic liquid crystal composition to the nematic liquid crystal composition.

In the first liquid crystal display element, said nematic liquid crystal composition has a main component formed of at least one kind of liquid crystal pyrimidine compound, and the following conditions are satisfied:

Δn×(k33/k11)/(main component ratio)<0.4

In the second liquid crystal display element, said nematic liquid crystal composition has a main component formed of (1) at least one kind of liquid crystal biphenyl compound, (2) at least one kind of liquid crystal terphenyl compound or (3) a mixture of at least one kind of liquid crystal biphenyl compound and at least one kind of liquid crystal terphenyl compound, and the following conditions are satisfied:

Δn×(k33/k11)/(main component ratio)<0.8

In the third liquid crystal display element, said nematic liquid crystal composition has a main component formed of at least one kind of liquid crystal ester compound, and the following conditions are satisfied:

Δn×(k33/k11)/(main component ratio)<0.25

In the fourth liquid crystal display element, said nematic liquid crystal composition has a main component formed of at least one kind of liquid crystal phenylcyclohexane (PCH) compound, and the following conditions are satisfied:

Δn×(k33/k11)/(main component ratio)<0.4

In the first liquid crystal display element, the main component of said nematic liquid crystal composition is formed of the liquid crystal pyrimidine compound exhibiting a relatively large Δn, and the conditions of (Δn×(k33/k11)/(main component ratio)<0.4) are satisfied. Therefore, it is practically possible to achieve excellent transparent display characteristics such as display characteristics of the black or another background color in the case of the liquid crystal display element of the reflection type. This excellent transparent display characteristics such as display characteristics of the black or another background color can be achieved together with the bright display owing to the relatively large value of Δn. Thereby, contrast in image display can be improved. The light reflectance in the focal conic state of this element may be about 4% or less.

In the second liquid crystal display element, the main component of said nematic liquid crystal composition is formed of at least one of the liquid crystal biphenyl compound or the liquid crystal terphenyl compound exhibiting a relatively large Δn, and the conditions of (Δn×(k33/k11)/(main component ratio)<0.8) are satisfied. Therefore, it is practically possible to achieve excellent transparent display characteristics such as display characteristics of black or another background color in the case of the liquid crystal display element of the reflection type. The excellent transparent display characteristics such as display characteristics of the black or another background color can be achieved together with the bright display owing to a relatively large value of Δn. Thereby, contrast in image display can be improved. The light reflectance in the focal conic state of this element may be about 8% or less.

In the third liquid crystal display element, the main component of said nematic liquid crystal composition is formed of the liquid crystal display ester compound, and the conditions of (Δn×(k33/k11)/(main component ratio)<0.25) are satisfied. Therefore, it is practically possible to achieve excellent transparent display characteristics such as display characteristics of the black or another background color in the case of the liquid crystal display element of the reflection type. At the same time, contrast in image display can be improved. The light reflectance in the focal conic state of this element may be about 4% or less.

In the fourth liquid crystal display element, the main component of said nematic liquid crystal composition is formed of the phenylcyclohexane (PCH), and the conditions of (66 n×(k33/k11)/(main component ratio)<0.4) are satisfied. Therefore, it is practically possible to achieve excellent transparent display characteristics such as display characteristics of the black or another background color in the case of the liquid crystal display element of the reflection type. At the same time, contrast in image display can be improved. The light reflectance in the focal conic state of this element may be about 4% or less.

In each of the first to fourth liquid crystal display elements, a polychromatic dye may be used as additive. Thus, the liquid crystal layer may contain at least the nematic liquid crystal composition, chiral agent and polychromatic dye.

The polychromatic dye may be added to the liquid crystal compounds of the first to fourth liquid crystal display elements. Thereby, the elements can have improved characteristics such as contrast for image display. Either a single kind of polychromatic dye or several kinds of polychromatic dyes may be used.

In the first to fourth liquid crystal display elements, if the liquid crystal layer contains the nematic liquid crystal composition, chiral agent and dichroic dye, the chiral agent may be preferably contained in 10% or more by weight of an amount of compound exhibiting the cholesteric phase in the liquid crystal layer, although the content is not restricted to the above range.

In any one of the above cases, it is desired that the chiral agent is 40% or less by weight in the whole liquid crystal composition. More preferably, this amount is in a range from 15% to 40% by weight, and further preferably from 20% to 40% by weight. If the amount were larger than 40% by weight, the low temperature characteristics would be impaired, and deposition of crystal and others would be liable to occur.

In the first to fourth liquid crystal display elements, electrodes may be formed on the paired substrates. For improving an insulating performance and a gas barrier performance, an insulating film(s) or an orientation film(s) made of an organic or inorganic material may be formed on the electrode-formed surface(s) of either or both of the substrates. The insulating film and the orientation control film can be employed when necessary.

The insulating film may be made of a resin material containing, e.g., acrylic, epoxy or urethane resin, and may also be made of a resin material containing, e.g., silicone or polyimide which is the same as the material of the orientation film. The insulating film may be made of a color filter or the like, which is prepared by mixing a dye into the foregoing resin material.

The substrate may be a glass substrate. Also, it may also be a flexible substrate having good transparency and made of, e.g., polycarbonate, polyether sulfone or polyethylene terephthalate. For improving a color purity, a dye may be added to the liquid crystal material. A switching element of a TFT or the like may be formed on the substrate.

For providing a strong self-holding property between the paired substrates, the substrates may be supported by columnar structures made of high polymer substance or material arranged therebetween. The columnar structure made of the high polymer substance or material may have any section such as a circular, rectangular or elliptical section. If the plurality of high polymer structures are arranged between the substrates, these structures may be located with or without regularity. These structures may be formed, e.g., in a photolithography method, in which an ultraviolet-setting monomer resist material or the like is applied on one of the substrates and irradiated with ultraviolet rays through a mask for removing unset portions, or a method in which a thermoplastic resin is applied on one of the substrates by screen printing and is pressed between the substrates under a heat, and is cooled to set it.

A net-like structures made of a high polymer material may be arranged between the paired substrates. Accordingly, the first to fourth liquid crystal display elements may be of a so-called polymer-dispersed type, in which the liquid crystal material is dispersed in the three-dimensional net-like structure of high polymers, or the three-dimensional structure of high polymers is formed in the liquid crystal material.

A gap between the paired substrates can be controlled by spacers. The spacer may have a spherical or rod-like form, and may be made of resin, silicone or the like. The spacer may have a fixing or adhering performance. The size of this spacer is appropriately determined depending on the desired gap size between the substrates, and is preferably in a range from about 1 μm to about 20 μm. It is desirable that a ratio from about 1/2 to about 1/200 is determined by the size of the spacer with respect to the size of the polymer structure (e.g., the columnar structure made of high polymers) supporting the paired substrates.

For preventing leakage of the liquid crystal composition, the periphery of the element may be sealed with a sealant. This sealant may be thermosetting or photo-setting adhesive such as epoxy resin or acrylic resin.

In the case where the liquid crystal material containing an additive exhibits the cholesteric phase, the state can be switched by a predetermined pulse voltage between a transparent state (focal conic state) for allowing passage of visible light and a selective reflection state (planar state) for selectively reflecting visible light.

In any one of the above cases, the first to fourth liquid crystal display elements may be of a layered type, in which the plurality of liquid crystal layers are employed.

In the first to fourth liquid crystal display elements, a light absorbing layer may be arranged on a rear surface of the element remote from the element observation side. When the liquid crystal layer is in the transparent state, the light absorber layer absorbs the light passed through the liquid crystal layer so that a background color such as black is displayed. In the liquid crystal display element of the layered type, the light absorber layer may be arranged on the outer surface (rear surface) of the liquid crystal layer which is remotest from the element observation side. Thereby, the light absorber layer absorbs the light passed through the respective liquid crystal layers so that the black or another background color is displayed when the respective liquid crystal layers are transparent.

The light absorber layer may be formed of black film or the like. Alternatively, coating such as black ink may be applied to form the light absorber layer.

Examples of the liquid crystal display elements will now be described with reference to the drawings.

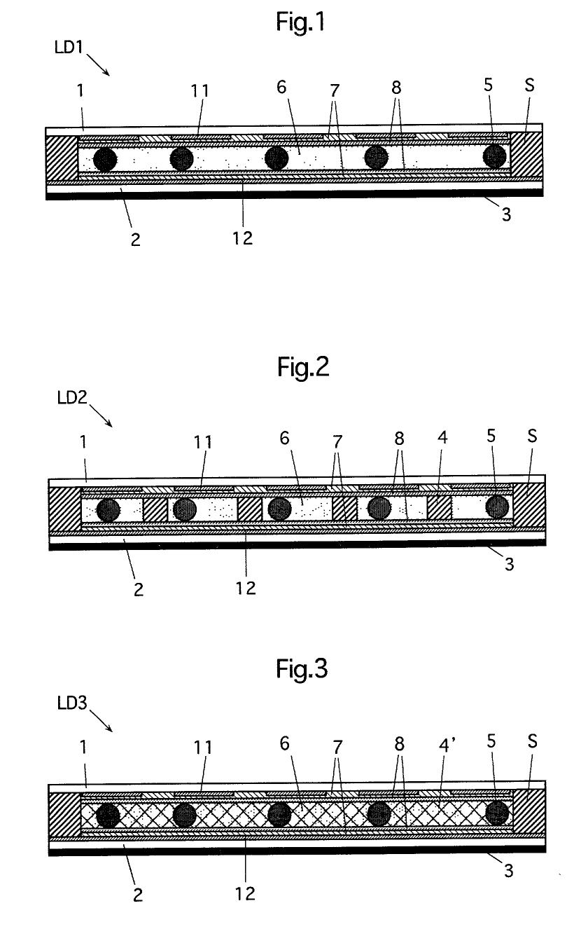

FIG. 1 is a schematic cross section showing an example of a liquid crystal display element according to the invention. FIG. 2 is a schematic cross section showing another example of the liquid crystal display element according to the invention, and FIG. 3 is a schematic cross section showing still another example of the liquid crystal display element according to the invention.

In FIGS. 2 and 3, liquid crystal display elements LD2 and LD3 are the substantially same as that of the liquid crystal display element LD1 shown in FIG. 1 except for that columnar resin structures 4 or a network resin structure 4′ is arranged between paired substrates 1 and 2.

The liquid crystal display elements LD1, LD2 and LD3 shown in FIGS. 1, 2 and 3 are of the reflection type can perform display in predetermined colors by a simple matrix drive manner.

In each of the liquid crystal display elements LD1, LD2 and LD3, a liquid crystal layer 6 containing at least nematic liquid crystal composition and a chiral agent is held between the pair of transparent resin film substrates 1 and 2. The amount of the chiral agent in the whole liquid crystal composition is 40% or less by weight. An amount larger than 40% by weight would lower the low temperature characteristics, and would tend to cause deposition of crystal or the like.

In each of the liquid crystal display elements LD1, LD2 and LD3, the liquid crystal layer 6 contains a liquid crystal material, which has a reflection wavelength in a visible range, and exhibits the cholesteric phase. The selective reflection wavelength of the liquid crystal layer may be changed depending on, e.g., the amount and kind of the added chiral agent and/or the kind of the nematic liquid crystal composition. Experimental examples, which will be described later, were adjusted to perform the selective reflection of red. A light absorber layer 3 for black is arranged on a rear surface of the element remote from the element observation side.

As a nematic liquid crystal composition contained in liquid crystal layer 6, the examples may employ the nematic liquid crystal composition, which contains liquid crystal pyrimidine compound as its main component, and satisfies the conditions of (Δn×(k33/k11)/(main component ratio)<0.4); the nematic liquid crystal composition, which contains at least one of a liquid crystal biphenyl compound and a liquid crystal terphenyl compound as its main component, and satisfies the conditions of (Δn×(k33/k11)/(main component ratio)<0.8); the nematic liquid crystal composition, which contains liquid crystal ester compound as its main component, and satisfies the conditions of (Δn×(k33/k11)/(main component ratio)<0.25); and the nematic liquid crystal composition, which contains liquid crystal phenylcyclohexane compound as its main component, and satisfies the conditions of (Δn×(k33/k11)/(main component ratio)<0.4), respectively.

In the above conditions, Δn is a refractive index anisotropy of the nematic liquid crystal composition, k33 is a bend elastic constant, k11 is a spray elastic constant, and the main component ratio is a content ratio (% by weight) of the main component of the nematic liquid crystal composition to the nematic liquid crystal composition.

The bend elastic constant k33 and spray elastic constant k11 are Frank elastic constants with respect to distortions in a bend mode and a spray mode, respectively. Further, the liquid crystal pyrimidine compound, liquid crystal biphenyl compound, liquid crystal terphenyl compound, liquid crystal ester compound and liquid crystal phenylcyclohexane (PCH) compound, which are the main components of the nematic liquid crystal composition (i.e., components contained at about 30% or more by weight in the nematic liquid crystal composition material), are formed of liquid crystal molecules, of which main skeletons have molecule structures expressed by pyrimidine, biphenyl, terphenyl, ester or phenylcyclohexane (PCH), respectively, and have ends formed of groups of alkyl, alkoxy, alkenyl, halogen or the like.

A plurality of belt-like transparent electrodes 11 and 12, which are parallel to each other with a fine space therebetween, are arranged on the transparent resin film substrates 1 and 2, respectively. The substrates 1 and 2 are opposed to each other such that the transparent electrodes 11 and 12 are perpendicular to each other, and regions where the transparent electrodes 11 and 12 cross each other form pixels, respectively.

For improving an insulating performance and a gas barrier performance, insulating films 7 made of an organic or inorganic material are formed on transparent electrodes 11 and 12, respectively. Further, orientation films 8 are formed on the electrodes 11 and 12 covered with the insulating films 7, respectively.

The paired transparent resin film substrates 1 and 2 in each of the embodiments are flexible, and are made of polyether sulfone (PES).

In the liquid crystal display elements LD2 and LD3 shown in FIGS. 2 and 3, columnar resin structures 4 or a network resin body or structure 4′ made of high polymer substance or material is arranged between the paired substrates 1 and 2 for providing a strong self-holding property.

More specifically, the liquid crystal display element LD2 in FIG. 2 is provided with the plurality of columnar structures (polymer composition stractures) 4 keeping the distance between the substrates. The columnar structure 4 may have any section such as a circular, rectangular or elliptical section, and these structures 4 may be located with or without regularity.

In the liquid crystal display element LD3 shown in FIG. 3, the network structure 4′ made of high polymer substance keeps the distance between the substrates. In the liquid crystal display element LD3, the liquid crystal material is dispersed in the three-dimensional network structure, or the three-dimensional structure of high polymer substance is formed in the liquid crystal material.

In the liquid crystal display elements LD1, LD2 and LD3 shown in FIGS. 1, 2 and 3, a gap between the paired substrates 1 and 2 is defined by spacers 5. This spacer 5 may be formed of a spherical or rod-like spacer made of resin, silicone or the like. The size of this spacer 5 is appropriately determined depending on the desired gap size between the substrates 1 and 2, is preferably in a range from about 1 μm to about 20 μm, and is equal to 9 μm in this embodiment. In the element LD2 shown in FIG. 2, a ratio from about 1/2 to about 1/200 is determined by the size of the spacer 5 with respect to the size of the columnar resin structure 4.

In each of the liquid crystal display elements LD1, LD2 and LD3 shown in FIGS. 1-3, a sealant or seal member S is provided for sealing the periphery of the element so that the liquid crystal composition is confined in the element without leakage.

In the liquid crystal layer 6, the liquid crystal material containing an additive exhibits the cholesteric phase, and a predetermined pulse may be applied across the transparent electrodes 11 and 12 arranged on the paired substrates 1 and 2 holding the liquid crystal layer therebetween. In response to the pulse voltage, the state can be switched between a transparent state (focal conic state) for allowing passage of visible light and a selective reflection state (planar state) for selectively reflecting visible light.

When white light such as natural light is emitted from the observation side to the liquid crystal display element, in which the liquid crystal layer 6 is in the selective reflection state, the liquid crystal layer 6 in the selective reflection state reflects the visible light of a specific wavelength, and the reflected light is viewed as a color. When the liquid crystal layer 6 is in the transparent state, the incident light passes through the liquid crystal layer 6. Therefore, the light absorbing layer 3 absorbs the incident light, and the black is displayed.

The liquid crystal display elements LD1, LD2 and LD3 shown in FIGS. 1-3 employ the nematic liquid crystal composition, of which main component is formed of the liquid crystal pyrimidine compound exhibiting a relatively large An, and satisfies the conditions of (Δn×(k33/k11)/(main component ratio)<0.4). Therefore, it is practically possible to achieve excellent transparent display (black display) characteristics. This excellent transparent display (black display) characteristics can be achieved together with the bright display owing to the relatively large value of Δn. Thereby, contrast in image display can be improved.

Also, the liquid crystal display elements LD1, LD2 and LD3 may employ the nematic liquid crystal composition, of which main component is formed of at least one of a liquid crystal biphenyl compound and a liquid crystal terphenyl compound exhibiting a relatively large An, and satisfies the conditions of (Δn×(k33/k11)/(main component ratio)<0.8). In these elements, it is practically possible to achieve excellent transparent display (black display) characteristics. This excellent transparent display (black display) characteristics can be achieved together with the bright display owing to the relatively large value of Δn. Thereby, contrast in image display can be improved.

Further, the liquid crystal display elements LD1, LD2 and LD3 may employ the nematic liquid crystal composition, of which main component is formed of the liquid crystal display ester compound, and satisfies the conditions of (Δn×(k33/k11)/(main component ratio)<0.25). In these elements, it is practically possible to achieve excellent transparent display (black display) characteristics. At the same time, contrast in image display can be improved.

Further, the liquid crystal display elements LD1, LD2 and LD3 may employ the nematic liquid crystal composition, of which main component is formed of the phenylcyclohexane (PCH), and satisfies the conditions of (Δn×(k33/k11)/(main component ratio)<0.4). In these elements, it is practically possible to achieve excellent transparent display (black display) characteristics. At the same time, contrast in image display can be improved.

The liquid crystal display elements LD1, LD2 and LD3 described above may use a dichroic dye as additive. The dichroic dye may be added to ,e.g., the liquid crystal compounds of the elements. Thereby, the elements can have improved characteristics such as contrast for image display. Either a single kind of dichroic dye or several kinds of dichroic dyes may be used. In this case, the chiral agent may be preferably contained in 10% or more by weight of compound exhibiting the cholesteric phase in the liquid crystal layer 6, although the amount is not restricted to the above range.

Description will now be given on experimental examples and comparative examples, although the invention is not restricted to them. In the following experimental examples (except for experimental examples 6 and 8), the liquid crystal display elements are the substantially same as the liquid crystal display element LD1 shown in FIG. 1. In the experimental examples 6 and 8, the liquid crystal display elements are the substantially same as the liquid crystal display elements LD2 and LD3 shown in FIGS. 2 and 3, respectively.

For determining the contrast or the like in the examples described below, the luminous reflectances (Y-values) were measured with a reflective type spectrocolorimeter CM-3700d (manufactured by Minolta Co., Ltd.). A smaller Y-value provides a higher transparency. The contrast is given by (Y-value in the high reflective state)/(Y-value in the low reflective state). In the liquid crystal display element in each of the experimental examples described below, a high reflectance state was attained when the liquid crystal cell (liquid crystal display element) entered the colored state, and a low reflectance state, in which the element became transparent or nearly transparent so that the black light absorber film could be viewed, was attained when the liquid crystal cell entered the colorless state. Accordingly, the contrast is represented as the reflectance ratio between specific color display and black display.

The experimental examples, which will now be described relate to the element for selectively reflecting red light. Naturally, the invention is not restricted to this, and can be applied to any liquid crystal display element, which can selectively reflect visible light of any color such as blue or green.

### EXPERIMENTAL EXAMPLE 1

Liquid crystal composition A used in this example contained, as the main component, the liquid crystal pyrimidine compound and had Δn of 0.24, k33/k11 of 0.8 and the main component ratio of 65% by weight. The chiral agent CB15 (manufactured by Merck & Co.) was added at 30% by weight to the composition A so that a liquid crystal composition a thus prepared could selectively reflect the light of a wavelength of about 680 nm.

Polyether sulfone (PES) film substrates were prepared. An insulating film HIM3000 (manufactured by Hitachi Chemical Co., Ltd.) of 2000 Å in thickness and an orientation film AL4552 (manufactured by JSR Corp.) of 800 Å in thickness were successively made on a transparent electrode-formed surface of one of the polyether sulfone (PES) film substrates. Spacers of 9 μm in diameter for gap control were dispersed on the film substrate having the above structure, and a sealant XN21S (manufactured by Mitsui Chemicals Co., Ltd.) was applied by screen printing to the periphery of the substrate while keeping an inlet for liquid crystal.

On the other film substrate, an insulating film HIM3000 (manufactured by Hitachi Chemical Co., Ltd.) of 2000 Å in thickness and an orientation film AL4552 (manufactured by JSR Corp.) of 800 Å in thickness were successively formed.

Then, these substrates were put together and heated at 150° C. for one hour while pressing them with a predetermined pressure, and then the liquid crystal composition a was vacuum-injected through the liquid crystal inlet.

Thus, the liquid crystal composition a made of the liquid crystal composition A and the chiral agent was supplied into the cell having the gap of 9 μm between the substrates. In this manner, a liquid crystal cell A1 was prepared. A black light absorbing layer was arranged on the rear surface of this cell remote from the element observation side.

Pulse voltages each having a width of 5 milliseconds were applied to the cell A1 for attaining the colored state (planar orientation) and the colorless state (focal conic state). In the colored and colorless states, the following Y-values and the reflectance with the wavelength of 400 nm were obtained. The drive voltage for the colored state (planar orientation) was 100 V, and the drive voltage for the colorless state (focal conic orientation) was 70 V.

Y-value (colorless): 1.9

Y-value (colored): 5.9

contrast ratio: 3.1

The reflectance with the wavelength 400 nm in the colorless state was 1.7%, and (Δn×(k33/k11)/(main component ratio)) was equal to 0.29.

By using the liquid crystal pyrimidine compound providing (Δn×(k33/k11)/(main component ratio)) smaller than 0.4 as described above, it was possible to achieve the element which provided the small Y-value of 1.9 in the colorless state, could remarkably suppress the scattering components, and could achieve good black display characteristics.

### COMPARATIVE EXAMPLE 1

Liquid crystal composition A′ used in this example contained, as the main component, the liquid crystal pyrimidine compound and had Δn of 0.22, k33/k11 of 1.3 and the main component ratio of 42% by weight. The chiral agent CB15 (manufactured by Merck & Co.) was added at 28% by weight to the composition A′ so that a liquid crystal composition a′ thus prepared could selectively reflect the light of a wavelength of about 680 nm.

In a manner similar to that of the experimental example 1, the cell was prepared, and the liquid crystal composition a′ was vacuum-injected into the cell.

Thus, the liquid crystal composition a′ made of the liquid crystal A′ and the chiral agent was supplied into the cell having the gap of 9 μm between the substrates. In this manner, a liquid crystal cell A1′ was prepared. A black light absorbing layer was arranged on the rear surface of this cell remote from the element observation side.

Pulse voltages each having a width of 5 milliseconds were applied to the cell A1′ for attaining the colored state (planar orientation) and the colorless state (focal conic state). In the colored and colorless states, the following Y-value and the reflectance with the wavelength of 400 nm were obtained. The drive voltage for the colored state (planar orientation) was 100 V, and the drive voltage for the colorless state (focal conic orientation) was 70 V.

Y-value (colorless): 3.4

Y-value (colored): 10.2

contrast ratio: 3.0

The reflectance with the wavelength 400 nm in the colorless state was 5.4%, and (Δn×(k33/k11)/(main component ratio)) was equal to 0.68.

By using the liquid crystal pyrimidine compound providing (Δn×(k33/k11)/(main component ratio)) equal to or larger than 0.4 as described above, the Y-value in the colorless state was 3.4 and thus large, and the element had bad black display characteristics causing very large scattered components.

### EXPERIMENTAL EXAMPLE 2

Liquid crystal composition B used in this example contained, as the main component, the liquid crystal biphenyl compound and had Δn of 0.22, k33/k11 of 1.3 and the main component ratio of 69% by weight. The chiral agent CB15 (manufactured by Merck & Co.) added at 30% by weight to the composition B so that liquid crystal composition b thus prepared could selectively reflect the light of a wavelength of about 680 nm.

A cell was prepared similarly to the experimental example 1, and the liquid crystal composition b was vacuum-injected into the cell.

Thus, the liquid crystal composition b made of the liquid crystal composition B and the chiral agent was supplied into the cell having the gap of 9 μm between the substrates. In this manner, a liquid crystal cell B1 was prepared. A black light absorbing layer was arranged on the rear surface of this cell remote from the element observation side.

Pulse voltages each having a width of 5 milliseconds were applied to the cell B1 for attaining the colored state (planar orientation) and the colorless state (focal conic state). In the colored and colorless states, the following Y-value and the reflectance with the wavelength of 400 nm were obtained. The drive voltage for the colored state (planar orientation) was 90 V, and the drive voltage for the colorless state (focal conic orientation) was 60 V.

Y-value (colorless): 2.3

Y-value (colored): 5.9

contrast ratio: 2.6

The reflectance with the wavelength 400 nm in the colorless state was 6.3%, and (Δn×(k33/k11)/(main component ratio)) was equal to 0.41.

By using the liquid crystal biphenyl compound providing (Δn×(k33/k11)/(main component ratio)) smaller than 0.8 as described above, it was possible to achieve the element which provided the small Y-value of 2.3 in the colorless state, could remarkably suppress the scattering components, and could achieve good black display characteristics.

### EXPERIMENTAL EXAMPLE 3

Liquid crystal B″ used in this example contained, as the main component, the liquid crystal terphenyl compound and had Δn of 0.239, k33/k11 of 1.3 and the main component ratio of 44% by weight. The chiral agent CB15 (manufactured by Merck & Co.) added at 30% by weight to the composition B″ so that liquid crystal composition b″ thus prepared could selectively reflect the light of a wavelength of about 680 nm.

A cell was prepared similarly to the experimental example 1, and the liquid crystal composition b″ was vacuum-injected into the cell.

Thus, the liquid crystal composition b″ made of the liquid crystal B″ and the chiral agent was supplied into the cell having the gap of 9 μm between the substrates. In this manner, a liquid crystal cell B1″ was prepared. A black light absorbing layer was arranged on the rear surface of this cell remote from the element observation side.

Pulse voltages each having a width of 5 milliseconds were applied to the cell B1″ for attaining the colored state (planar orientation) and the colorless state (focal conic state). In the colored and colorless states, the following Y-value and the reflectance with the wavelength of 400 nm were obtained. The drive voltage for the colored state (planar orientation) was 105 V, and the drive voltage for the colorless state (focal conic orientation) was 75 V.

Y-value (colorless): 2.3

Y-value (colored): 6.5

contrast ratio: 2.8

The reflectance with the wavelength 400 nm in the colorless state was 6.7%, and (Δn×(k33/k11)/(main component ratio)) was equal to 0.706.

By using the liquid crystal terphenyl compound providing (Δn×(k33/k11)/(main component ratio)) smaller than 0.8 as described above, it was possible to achieve the element which provided the small Y-value of 2.3 in the colorless state, could remarkably suppress the scattering components, and could achieve good black display characteristics.

### COMPARATIVE EXAMPLE 2

Liquid crystal B′ used in this example contained, as the main component, the liquid crystal biphenyl compound and the liquid crystal terphenyl compound, and had Δn of 0.27, k33/k11 of 1.93 and the main component ratio of 52% by weight. The chiral agent CB15 (manufactured by Merck & Co.) added at 28% by weight to the composition B′ so that liquid crystal composition b′ thus prepared could selectively reflect the light of a wavelength of about 680 nm.

In a manner similar to that of the experimental example 1, the cell was prepared, and the liquid crystal composition b′ was vacuum-injected into the cell.

Thus, the liquid crystal composition b′ made of the liquid crystal B′ and the chiral agent was supplied into the cell having the gap of 9 μm between the substrates. In this manner, a liquid crystal cell B1′ was prepared. A black light absorbing layer was arranged on the rear surface of this cell remote from the element observation side.

Pulse voltages each having a width of 5 milliseconds were applied to the cell B1′ for attaining the colored state (planar orientation) and the colorless state (focal conic state). In the colored and colorless states, the following Y-value and the reflectance with the wavelength of 400 nm were obtained. The drive voltage for the colored state (planar orientation) was 100 V, and the drive voltage for the colorless state (focal conic orientation) was 70 V.

Y-value (colorless): 4.5

Y-value (colored): 11

contrast ratio: 2.4

The reflectance with the wavelength 400 nm in the colorless state was 9.5%, and (Δn×(k33/k11)/(main component ratio)) was equal to 1.00.

By using the liquid crystal biphenyl compound and the liquid crystal terphenyl compound providing (Δn×(k33/k11)/(main component ratio)) equal to or larger than 0.8 as described above, the Y-value in the colorless state was 4.5 and thus large, and the element had bad black display characteristics causing very large scattered components.

### EXPERIMENTAL EXAMPLE 4

Liquid crystal composition C used in this example contained, as the main component, the liquid crystal ester compound and had Δn of 0.13, k33/k11 of 1.1 and the main component ratio of 60% by weight. The chiral agent CB15 (manufactured by Merck & Co.) added at 30% by weight to the composition C so that liquid crystal composition c thus prepared could selectively reflect the light of a wavelength of about 680 nm.

A cell was prepared similarly to the experimental example 1, and the liquid crystal composition c was vacuum-injected into the cell.

Thus, the liquid crystal composition c made of the liquid crystal C and the chiral agent was supplied into the cell having the gap of 9 μm between the substrates. In this manner, a liquid crystal cell C1 was prepared. A black light absorbing layer was arranged on the rear surface of this cell remote from the element observation side.

Pulse voltages each having a width of 5 milliseconds were applied to the cell C1 for attaining the colored state (planar orientation) and the colorless state (focal conic state). In the colored and colorless states, the following Y-value and the reflectance with the wavelength of 400 nm were obtained. The drive voltage for the colored state (planar orientation) was 85 V, and the drive voltage for the colorless state (focal conic orientation) was 50 V.

Y-value (colorless): 2.3

Y-value (colored): 5.9

contrast ratio: 2.6

The reflectance with the wavelength 400 nm in the colorless state was 3.5%, and (Δn×(k33/k11)/(main component ratio)) was equal to 0.24.

By using the liquid crystal ester compound providing (Δn×(k33/k11)/(main component ratio)) smaller than 0.25 as described above, it was possible to achieve the element which provided the small Y-value of 2.3 in the colorless state, could remarkably suppress the scattering components, and could achieve good black display characteristics.

### COMPARATIVE EXAMPLE 3

Liquid crystal composition C′ used in this example contained, as the main component, the liquid crystal ester compound and had Δn of 0.20, k33/k11 of 1.33 and the main component ratio of 47% by weight. The chiral agent CB15 (manufactured by Merck & Co.) added at 28% by weight to the composition C′ so that liquid crystal composition c′ thus prepared could selectively reflect the light of a wavelength of about 680 nm.

In a manner similar to that of the experimental example 1, the cell was prepared, and the liquid crystal composition c′ was vacuum-injected into the cell.

Thus, the liquid crystal composition c′ made of the liquid crystal C′ and the chiral agent was supplied into the cell having the gap of 9 μm between the substrates. In this manner, a liquid crystal cell C1′ was prepared. A black light absorbing layer was arranged on the rear surface of this cell remote from the element observation side.

Pulse voltages each having a width of 5 milliseconds were applied to the cell C1′ for attaining the colored state (planar orientation) and the colorless state (focal conic state). In the colored and colorless states, the following Y-value and the reflective index with the wavelength of 400 nm were obtained. The drive voltage for the colored state (planar orientation) was 85 V, and the drive voltage for the colorless state (focal conic orientation) was 50 V.

Y-value (colorless): 3.4

Y-value (colored): 10.2

contrast ratio: 3.0

The reflectance with the wavelength 400 nm in the colorless state was 5.4%, and (Δn×(k33/k11)/(main component ratio)) was equal to 0.56.

By using the liquid crystal ester compound providing (Δn×(k33/k11)/(main component ratio)) equal to or larger than 0.25 as described above, the Y-value in the colorless state was 3.4 and thus large, and the element had bad black display characteristics causing very large scattered components.

### EXPERIMENTAL EXAMPLE 5

Liquid crystal composition D used in this example contained, as the main component, the liquid crystal phenylcyclohexane (PCH) compound and had Δn of 0.13, k33/k11 of 1.27 and the main component ratio of 50% by weight. The chiral agent CB15 (manufactured by Merck & Co.) added at 30% by weight to the composition D so that liquid crystal composition d thus prepared could selectively reflect the light of a wavelength of about 680 nm.

A cell was prepared similarly to the experimental example 1, and the liquid crystal composition d was vacuum-injected into the cell.

Thus, the liquid crystal composition d made of the liquid crystal D and the chiral agent was supplied into the cell having the gap of 9 μm between the substrates. In this manner, a liquid crystal cell D1 was prepared. A black light absorbing layer was arranged on the rear surface of this cell remote from the element observation side.

Pulse voltages each having a width of 5 milliseconds were applied to the cell D1 for attaining the colored state (planar orientation) and the colorless state (focal conic state). In the colored and colorless states, the following Y-value and the reflectance with the wavelength of 400 nm were obtained. The drive voltage for the colored state (planar orientation) was 90 V, and the drive voltage for the colorless state (focal conic orientation) was 60 V.

Y-value (colorless): 2.0

Y-value (colored): 6.0

contrast ratio: 3.0

The reflectance with the wavelength 400 nm in the colorless state was 3.8%, and (Δn×(k33/k11)/(main component ratio)) was equal to 0.33.

By using the liquid crystal PCH compound providing (Δn×(k33/k11)/(main component ratio)) smaller than 0.4 as described above, it was possible to achieve the element which provided the small Y-value of 2.0 in the colorless state, could remarkably suppress the scattering components, and could achieve good black display characteristics.

### COMPARATIVE EXAMPLE 4

Liquid crystal composition D′ used in this example contained, as the main component, the liquid crystal phenylcyclohexane (PCH) compound and had Δn of 0.20, k33/k11 of 1.33 and the main component ratio of 48% by weight. The chiral agent CB15 (manufactured by Merck & Co.) added at 30% by weight to the composition D′ so that liquid crystal composition d′ thus prepared could selectively reflect the light of a wavelength of about 680 nm.

In a manner similar to that of the experimental example 1, the cell was prepared, and the liquid crystal composition d′ was vacuum-injected into the cell.

Thus, the liquid crystal composition d′ made of the liquid crystal D′ and the chiral agent was supplied into the cell having the gap of 9 μm between the substrates. In this manner, a liquid crystal cell D1′ was prepared. A black light absorbing layer was arranged on the rear surface of this cell remote from the element observation side.

Pulse voltages each having a width of 5 milliseconds were applied to the cell D1′ for attaining the colored state (planar orientation) and the colorless state (focal conic state). In the colored and colorless states, the following Y-value and the reflectance with the wavelength of 400 nm were obtained. The drive voltage for the colored state (planar orientation) was 90 V, and the drive voltage for the colorless state (focal conic orientation) was 60 V.

Y-value (colorless): 3.5

Y-value (colored): 6.0

contrast ratio: 1.7

The reflectance with the wavelength 400 nm in the colorless state was 5.9%, and (Δn×(k33/k11)/(main component ratio)) was equal to 0.55.

By using the liquid crystal PCH compound providing (Δn×(k33/k11)/(main component ratio)) equal to or larger than 0.4 as described above, the Y-value in the colorless state was 3.5 and thus large, and the element had bad black display characteristics causing very large scattered components.

### EXPERIMENTAL EXAMPLE 6

Liquid crystal composition E used in this example contained, as the main component, the liquid crystal ester compound and had Δn of 0.23, k33/k11 of 0.84 and the main component ratio of 84% by weight. The chiral agent CB15 (manufactured by Merck & Co.) added at 30% by weight to the composition E so that liquid crystal composition e thus prepared could selectively reflect the light of a wavelength of about 680 nm.

Polyether sulfone (PES) film substrates were prepared. An insulating film HIM3000 (manufactured by Hitachi Chemical Co., Ltd.) of 2000 Å in thickness and an orientation film AL4552 (manufactured by JSR Corp.) of 800 Å in thickness were successively made on a transparent electrode-formed surface of one of the polyether sulfone (PES) film substrates. Spacers of 9 μm in diameter for gap control were dispersed on the film substrate having the above structure, and a sealant XN21S (manufactured by Mitsui Chemicals Co., Ltd.) was applied by screen printing to the periphery of the substrate while keeping an inlet for liquid crystal.

On the other film substrate, an insulating film HIM3000 (manufactured by Hitachi Chemical Co., Ltd.) of 2000 Å in thickness and an orientation film AL4552 (manufactured by JSR Corp.) of 800 Å in thickness were successively formed.

Then, ink containing thermosetting resin as a main component was laid over a metal mask provided with holes, each of which had a diameter of about 100 μm and was spaced by about 500 μm from each other, and was applied to the substrate by a screen printing with a squeegee. Thereby, columnar structures each having a circular section and a height of about 10 μm were formed.

Then, the liquid crystal composition e, of which amount was calculated from the gap between the substrates, was applied onto the substrates, respectively.

These substrates were put together by a joining device and heated at 150° C. for one hour while pressing them with a predetermined pressure, and then were cooled so that a liquid crystal cell E1 was prepared. A black light absorbing layer was arranged on the rear surface of this cell remote from the element observation side.

Pulse voltages each having a width of 5 milliseconds were applied to the cell E1 for attaining the colored state (planar orientation) and the colorless state (focal conic state). In the colored and colorless states, the following Y-value and the reflectance with the wavelength of 400 nm were obtained. The drive voltage for the colored state (planar orientation) was 85 V, and the drive voltage for the colorless state (focal conic orientation) was 55 V.

Y-value (colorless): 2.8

Y-value (colored): 4.5

contrast ratio: 1.6

The reflectance with the wavelength 400 nm in the colorless state was 1.7%, and (Δn×(k33/k11)/(main component ratio)) was equal to 0.23.

By using the liquid crystal ester compound providing (Δn×(k33/k11)/(main component ratio)) smaller than 0.25 as described above, it was possible to achieve the element which provided the small Y-value of 2.8 in the colorless state, could remarkably suppress the scattering components, and could achieve good black display characteristics.

### EXPERIMENTAL EXAMPLE 7

Liquid crystal composition E used in this example contained, as the main component, the liquid crystal ester compound and had Δn of 0.23, k33/k11 of 0.84 and the main component ratio of 84% by weight. The chiral agent CB15 (manufactured by Merck & Co.) added at 30% by weight to the composition E so that liquid crystal composition thus prepared could selectively reflect the light of a wavelength of about 680 nm. Further, dichroic dye SI-426 (manufactured by Mitsui Chemicals Co., Ltd.) was added at 0.3% by weight so that liquid crystal composition e′ was prepared.

A cell was prepared similarly to the experimental example 1, and the liquid crystal composition e′ was vacuum-injected into the cell.

Thus, the liquid crystal composition e′ was supplied into the cell having the gap of 9 μm between the substrates. In this manner, a liquid crystal cell E1′ was prepared. A black light absorbing layer was arranged on the rear surface of this cell remote from the element observation side.

Pulse voltages each having a width of 5 milliseconds were applied to the cell E1′ for attaining the colored state (planar orientation) and the colorless state (focal conic state). In the colored and colorless states, the following Y-value and the reflectance with the wavelength of 400 nm were obtained. The drive voltage for the colored state (planar orientation) was 85 V, and the drive voltage for the colorless state (focal conic orientation) was 55 V.

Y-value (colorless): 2.0

Y-value (colored): 4.5

contrast ratio: 2.3

The reflectance with the wavelength 400 nm in the colorless state was 1.6%, and (Δn×(k33/k11)/(main component ratio)) was equal to 0.23.

By using the liquid crystal ester compound providing (Δn×(k33/k11)/(main component ratio)) smaller than 0.25 as described above, it was possible to achieve the element which provided the small Y-value of 2.0 in the colorless state, could remarkably suppress the scattering components, and could achieve good black display characteristics.

### EXPERIMENTAL EXAMPLE 8

Liquid crystal composition E used in this example contained, as the main component, the liquid crystal ester compound and had Δn of 0.23, k33/k11 of 0.84 and the main component ratio of 84% by weight. The chiral agent CB15 (manufactured by Merck & Co.) added at 30% by weight to the composition E so that liquid crystal composition e thus prepared could selectively reflect the light of a wavelength of about 680 nm.

A cell was prepared similarly to the experimental example 1.

Then, the diacrylate monomer R684 (manufactured by Nippon Kayaku Co., Ltd.) which contained the photo-polymerization initiator IRUGACURE 184 (manufactured by Nagase-CIBA Ltd.) added at 3% by weight thereto was added at 1% by weight to the liquid crystal compound e so that a mixture e′ was prepared. The mixture e″ thus prepared was vacuum-injected into the cell.

Thus, the mixture e″ was supplied into the cell having the gap of 9 μm between the substrates. In this manner, a liquid crystal cell E1″ was prepared. Thereafter, the cell was irradiated with ultraviolet light by a high-pressure mercury lamp with the output of 10 mW/cm² for 10 minutes so that phase isolation occurred, and the liquid crystal display element of the polymer-dispersed type was formed. Thereby, a net-like structure of resin was formed. A black light absorbing layer was arranged on the rear surface of this cell remote from the element observation side.

Pulse voltages each having a width of 5 milliseconds were applied to the cell E1″ for attaining the colored state (planar orientation) and the colorless state (focal conic state). In the colored and colorless states, the following Y-value and the reflectance with the wavelength of 400 nm were obtained. The drive voltage for the colored state (planar orientation) was 95 V, and the drive voltage for the colorless state (focal conic orientation) was 65 V.

Y-value (colorless): 2.8

Y-value (colored): 5.1

contrast ratio: 1.8

The reflectance with the wavelength 400 nm in the colorless state was 1.8%, and (Δn×(k33/k11)/(main component ratio)) was equal to 0.23.

By using the liquid crystal ester compound providing (Δn×(k33/k11)/(main component ratio)) smaller than 0.25 as described above, it was possible to achieve the element which provided the small Y-value of 2.0 in the colorless state, could remarkably suppress the scattering components, and could achieve good black display characteristics.

The foregoing experimental examples and the comparative examples can be summarized as follows:

### EXPERIMENTAL EXAMPLE 1

liquid crystal A

Δn=0.24, k33/k11 =0.8, and main component ratio=65 wt. %

PES substrate

liquid crystal pyrimidine compound achieving ((Δn×(k33/k11)/(main component ratio))<0.4)

Y-value (colorless)=1.9

### COMPARATIVE EXAMPLE 1

liquid crystal composition A′

Δn=0.22, k33/k11=1.3, and main component ratio=42 wt. %

PES substrate

liquid crystal pyrimidine compound achieving ((Δn×(k33/k11)/(main component ratio))≧0.4)

Y-value (colorless)=3.4

### EXPERIMENTAL EXAMPLE 2

liquid crystal composition B

Δn=0.22, k33/k11=1.3, and main component ratio=69 wt. %

PES substrate

liquid crystal biphenyl compound achieving ((Δn×(k33/k11)/(main component ratio))<0.8)

Y-value (colorless)=2.3

### EXPERIMENTAL EXAMPLE 3

liquid crystal composition B″

Δn=0.239, k33/k11=1.3, and main component ratio=44 wt. %

PES substrate

liquid crystal terphenyl compound achieving ((Δn×(k33/k11)/(main component ratio))<0.8)

Y-value (colorless)=2.3

### COMPARATIVE EXAMPLE 2

liquid crystal composition B′

Δn=0.27, k33/k11=1.93, and main component ratio=52 wt. %

PES substrate

liquid crystal biphenyl compound and liquid crystal terphenyl compound achieving ((Δn×(k33/k11)/(main component ratio))≧0.8)

Y-value (colorless)=4.5

### EXPERIMENTAL EXAMPLE 4

liquid crystal composition C

Δn=0.13, k33/k11=1.1, and main component ratio=60 wt. %

PES substrate

liquid crystal ester compound achieving ((Δn×(k33/k11)/(main component ratio))<0.25)

Y-value (colorless)=2.3

### COMPARATIVE EXAMPLE 3

liquid crystal composition C′

Δn=0.20, k33/k11=1.33, and main component ratio=47 wt. %

PES substrate

liquid crystal ester compound achieving ((Δn×(k33/k11)/(main component ratio))≧0.25)

Y-value (colorless)=3.4

### EXPERIMENTAL EXAMPLE 5

liquid crystal composition D

Δn=0.13, k33/k11=1.27, and main component ratio=50 wt. %

PES substrate

liquid crystal PCH compound achieving ((Δn×(k33/k11)/(main component ratio))<0.4)

Y-value (colorless)=2.0

### COMPARATIVE EXAMPLE 4

liquid crystal composition D′

Δn=0.20, k33/k11=1.33, and main component ratio=48 wt. %

PES substrate

liquid crystal PCH compound achieving ((Δn×(k33/k11)/(main component ratio))≧0.4)

Y-value (colorless)=3.5

### EXPERIMENTAL EXAMPLE 6

liquid crystal composition E

Δn=0.23, k33/k11=0.84, and main component ratio=84 wt. %

PES substrate

liquid crystal ester compound achieving ((Δn×(k33/k11)/(main component ratio))<0.25)

Columnar structures were prepared by printing.

Y-value (colorless)=2.8

### EXPERIMENTAL EXAMPLE 7

liquid crystal composition E

Δn=0.23, k33/k11=0.84, and main component ratio=84 wt. %

PES substrate

liquid crystal ester compound achieving ((Δn×(k33/k11)/(main component ratio))<0.25)

G-HCh liquid crystal element containing dichromatic dye

Y-value (colorless)=2.0

### EXPERIMENTAL EXAMPLE 8

liquid crystal composition E

Δn=0.23, k33/k11=0.84, and main component ratio=84 wt. %

PES substrate

liquid crystal ester compound achieving ((Δn×(k33/k11)/(main component ratio))<0.25)

polymer-dispersed liquid crystal element

Y-value (colorless)=2.8

### LIQUID CRYSTAL COMPOSITIONS

liquid crystal composition A: pyrimidine compound (65 wt. %), CCH-contained compound, tricyclic P-type

liquid crystal composition A′: pyrimidine compound (42 wt. %), PCH-contained compound, tricyclic N-type

liquid crystal composition B: cyanobiphenyl compound (69 wt. %), dicyclic N-type, tricyclic N-type

liquid crystal composition B′: biphenyl compound+terphenyl compound (52 wt. %), dicyclic N-type

liquid crystal composition B″: P-type terphenyl compound (44 wt. %), tricyclic N-type, dicyclic N-type

liquid crystal composition C: ester compound (60 wt. %), PCH compound, tolan compound

liquid crystal composition C′: ester compound (47 wt. %), tricyclic N-type, dicyclic N-type

liquid crystal composition D: PCH compound (50 wt. %), tricyclic N-type, dicyclic N-type

liquid crystal composition D′: PCH compound (48 wt. %), tricyclic N-type, tolan compound

liquid crystal composition E: ester compound (84 wt. %), tricyclic N-type, CCH compound

As described above, the liquid crystal display elements according to the invention, which were prepared in the experimental examples 1-8, have the Y-values in the colorless state, which are in a range of small values from 1.9 to 2.8, and can provide good black display characteristics with extremely small scattering components. In contrast to this, the liquid crystal display elements prepared in the comparative examples 1-4 provide the Y-values in the colorless state, which are all in a range of large values from 3.4 to 4.5, and provide bad black display characteristics with extremely large scattering components.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A liquid crystal display element, wherein a liquid crystal layer including at least nematic liquid crystal composition and a chiral agent is held between a pair of substrates, said nematic liquid crystal composition has a main component formed of at least one kind of liquid crystal pyrimidine compound, and the following conditions are satisfied:
Δn×(k33/k11)/(main component ratio)<0.4
where Δn is a refractive index anisotropy of said nematic liquid crystal composition, k33 is a bend elastic constant of said nematic liquid crystal composition, k11 is a spray elastic constant of said nematic liquid crystal composition, and the main component ratio is a content ratio (% by weight) of the main component of said nematic liquid crystal composition to said nematic liquid crystal composition.

2. A liquid crystal display element, wherein a liquid crystal layer including at least nematic liquid crystal composition and a chiral agent is held between a pair of substrates, said nematic liquid crystal composition has a main component formed of (1) at least one kind of liquid crystal biphenyl compound, (2) at least one kind of liquid crystal terphenyl compound, or (3) a mixture of at least one kind of liquid crystal biphenyl compound and at least one kind of liquid crystal terphenyl compound, and the following conditions are satisfied:
Δn×(k33/k11)/(main component ratio)<0.8
where Δn is a refractive index anisotropy of said nematic liquid crystal composition, k33 is a bend elastic constant of said nematic liquid crystal composition, k11 is a spray elastic constant of said nematic liquid crystal composition, and the main component ratio is a content ratio (% by weight) of the main component of said nematic liquid crystal composition to said nematic liquid crystal composition.

3. A liquid crystal display element, wherein a liquid crystal layer including at least nematic liquid crystal composition and a chiral agent is held between a pair of substrates, said nematic liquid crystal composition has a main component formed of at least one kind of liquid crystal ester compound, and the following conditions are satisfied:
Δn×(k33/k11)/(main component ratio)<0.25
where Δn is a refractive index anisotropy of said nematic liquid crystal composition, k33 is a bend elastic constant of said nematic liquid crystal composition, k11 is a spray elastic constant of said nematic liquid crystal composition, and the main component ratio is a content ratio (% by weight) of the main component of said nematic liquid crystal composition to said nematic liquid crystal composition.

4. A liquid crystal display element, wherein a liquid crystal layer including at least nematic liquid crystal composition and a chiral agent is held between a pair of substrates, said nematic liquid crystal composition has a main component formed of at least one kind of liquid crystal phenylcyclohexane compound, and the following conditions are satisfied:
Δn×(k33/k11)/(main component ratio)<0.4
where Δn is a refractive index anisotropy of said nematic liquid crystal composition, k33 is a bend elastic constant of said nematic liquid crystal composition, k11 is a spray elastic constant of said nematic liquid crystal composition, and the main component ratio is a content ratio (% by weight) of the main component of said nematic liquid crystal composition to said nematic liquid crystal composition.

5. The liquid crystal display element according to claim 1, wherein
said liquid crystal layer contains at least the nematic liquid crystal composition, the chiral agent and a dichroic dye.

6. The liquid crystal display element according to claim 2, wherein
said liquid crystal layer contains at least the nematic liquid crystal composition, the chiral agent and a dichroic dye.

7. The liquid crystal display element according to claim 3, wherein
said liquid crystal layer contains at least the nematic liquid crystal composition, the chiral agent and a dichroic dye.

8. The liquid crystal display element according to claim 4, wherein
said liquid crystal layer contains at least the nematic liquid crystal composition, the chiral agent and a dichroic dye.

9. The liquid crystal display element according to claim 5, wherein
said chiral agent is contained at 10% by weight or more of an amount of compound exhibiting the cholesteric phase in said liquid crystal layer.

10. The liquid crystal display element according to claim 6, wherein
said chiral agent is contained at 10% by weight or more of an amount of compound exhibiting the cholesteric phase in said liquid crystal layer.

11. The liquid crystal display element according to claim 7, wherein
said chiral agent is contained at 10% by weight or more of an amount of compound exhibiting the cholesteric phase in said liquid crystal layer.

12. The liquid crystal display element according to claim 8, wherein
said chiral agent is contained at 10% by weight or more of an amount of compound exhibiting the cholesteric phase in said liquid crystal layer.

13. The liquid crystal display element according to claim 1, wherein
a columnar structure made of high polymer substance is arranged between said paired substrates.

14. The liquid crystal display element according to claim 2, wherein
a columnar structure made of high polymer substance is arranged between said paired substrates.

15. The liquid crystal display element according to claim 3, wherein
a columnar structure made of high polymer substance is arranged between said paired substrates.

16. The liquid crystal display element according to claim 4, wherein
a columnar structure made of high polymer substance is arranged between said paired substrates.

17. The liquid crystal display element according to claim 5, wherein
a columnar structure made of high polymer substance is arranged between said paired substrates.

18. The liquid crystal display element according to claim 6, wherein
a columnar structure made of high polymer substance is arranged between said paired substrates.

19. The liquid crystal display element according to claim 7, wherein
a columnar structure made of high polymer substance is arranged between said paired substrates.

20. The liquid crystal display element according to claim 8, wherein
a columnar structure made of high polymer substance is arranged between said paired substrates.

21. The liquid crystal display element according to claim 9, wherein
a columnar structure made of high polymer substance is arranged between said paired substrates.

22. The liquid crystal display element according to claim 10, wherein
a columnar structure made of high polymer substance is arranged between said paired substrates.

23. The liquid crystal display element according to claim 11, wherein
a columnar structure made of high polymer substance is arranged between said paired substrates.

24. The liquid crystal display element according to claim 12, wherein
a columnar structure made of high polymer substance is arranged between said paired substrates.

25. The liquid crystal display element according to claim 1, wherein
a network structure made of high polymer substance is arranged between said paired substrates.

26. The liquid crystal display element according to claim 2, wherein
a network structure made of high polymer substance is arranged between said paired substrates.

27. The liquid crystal display element according to claim 3, wherein
a network structure made of high polymer substance is arranged between said paired substrates.

28. The liquid crystal display element according to claim 4, wherein
a network structure made of high polymer substance is arranged between said paired substrates.

29. The liquid crystal display element according to claim 5, wherein
a network structure made of high polymer substance is arranged between said paired substrates.

30. The liquid crystal display element according to claim 6, wherein
a network structure made of high polymer substance is arranged between said paired substrates.

31. The liquid crystal display element according to claim 7, wherein
a network structure made of high polymer substance is arranged between said paired substrates.

32. The liquid crystal display element according to claim 8, wherein
a network structure made of high polymer substance is arranged between said paired substrates.

33. The liquid crystal display element according to claim 9, wherein
a network structure made of high polymer substance is arranged between said paired substrates.

34. The liquid crystal display element according to claim 10, wherein
a network structure made of high polymer substance is arranged between said paired substrates.

35. The liquid crystal display element according to claim 11, wherein
a network structure made of high polymer substance is arranged between said paired substrates.

36. The liquid crystal display element according to claim 12, wherein
a network structure made of high polymer substance is arranged between said paired substrates.

37. The liquid crystal display element according to claim 1, wherein
an amount of said main component formrd of said liquid crystal compound in said nematic liquid crystal composition is in a range from 30% to 90% by weight.

38. The liquid crystal display element according to claim 2, wherein
an amount of said main component formrd of said liquid crystal compound in said nematic liquid crystal composition is in a range from 30% to 90% by weight.

39. The liquid crystal display element according to claim 3, wherein
an amount of said main component formrd of said liquid crystal compound in said nematic liquid crystal composition is in a range from 30% to 90% by weight.

40. The liquid crystal display element according to claim 4, wherein
an amount of said main component formrd of said liquid crystal compound in said nematic liquid crystal composition is in a range from 30% to 90% by weight.
